(19) United States
(12) Patent Application Publication
(10) Pub. No.: US 2026/0065744 A1
(43) Pub. Date: Mar. 5, 2026

(54) Personal Analytics and Sports Statistics System

(71) Applicant: Personal Analytics and Sports Statistics, LLC, Plano, TX (US)

(72) Inventors: S. George ALFONSO, Plano, TX (US); Brad MORSE, Westminster, CO (US)

(21) Appl. No.: 19/318,304

(22) Filed: Sep. 3, 2025

Related U.S. Application Data
(60) Provisional application No. 63/690,611, filed on Sep. 4, 2024.

(51) Int. Cl. G07F 17/32

(52) U.S. Cl. CPC G07F 17/323; G07F 17/3237; G07F 17/3258; G07F 17/3279

(57) ABSTRACT

A computer program for managing and analyzing a user's personal wagering data to generate real-time personalized wagering statistics for the user's review. When executed by a processor, the computer program causes the processor to receive the user's personal wagering data and track the outcomes of games. The processor executes an algorithm to analyze the user's wagering data and generate personalized wagering statistics. The processor generates an output illustrating the personalized wagering statistics and the output is delivered to a user interface for the user's review.

### CROSS-REFERENCE TO RELATED APPLICATIONS

The present application is related to U.S. Provisional Ser. No. 63/690,611 filed Sep. 4, 2024, entitled “Personal Analytics and Sports Statistics System”. The present application hereby claims priority under 35 U.S. C. § 119(e) to U.S. Provisional Ser. No. 63/690,611 The above-identified provisional patent application is hereby incorporated by reference in its entirety.

### TECHNICAL FIELD

The present disclosure relates in general to the field of computer programs, and more particularly to a novel computer program for managing and analyzing personal wagering data, as well as a system and methods of use.

### BACKGROUND

Sports betting has seen rapid growth in recent years, driven in large part by the expansion of legal markets and the rise of online betting platforms. While in-person betting at casinos and sportsbooks remains popular, an increasing number of bettors now place wagers online through mobile apps and websites, making sports betting more accessible than ever. Following the legalization of sports betting in many U.S. states, the industry has attracted a wide range of participants—from casual fans to experienced bettors—fueling demand for more sophisticated wagering tools and strategies.

Many bettors continue to rely on instinct or personal bias when placing bets, often favoring familiar teams or players without significant data to support their choices. Objective, data-driven analysis of the bettor's wagering history is essential in order to allow the bettor to make more informed decisions, but tracking personal wagering data across various players, games, sports, and bet types can be difficult and time-consuming. Reviewing and analyzing this data in a meaningful way poses additional challenges, particularly for those looking to refine their strategies over time. As a result, there is a growing need for streamlined tools that can help bettors collect, organize, and interpret personal wager performance data more effectively.

### SUMMARY

Novel aspects of the present disclosure are directed to a non-transitory computer-readable medium storing instructions that, when executed by one or more processors, cause the one or more processors to perform operations for analyzing a user's personal wagering results and wagering related data (“Wagering Data”). The operations comprise receiving the user's personal Wagering Data, tracking outcomes of a plurality of games, executing an algorithm to analyze the user's Wagering Data and generate personalized wagering statistics, and generating an output illustrating the user's personalized wagering statistics.

In another embodiment, novel aspects of the disclosed principles are directed to a system for generating personalized wagering statistics, comprising a database, a computing device, and a user interface. The database is configured to receive and store the user's Wagering Data and game information. The computing device is configured to analyze the user's Wagering Data and generate periodic and/or real-time personalized wagering statistics. The user interface is configured to present the personalized wagering statistics to the user through easy-to-read charts, graphs and tables. The database, computing device, and user interface are communicatively coupled.

In another embodiment, novel aspects of the disclosed principles are directed to a method for generating personalized wagering statistics, comprising the steps of receiving the user's Wagering Data; tracking outcomes of a plurality of games; executing, with a computing device, an algorithm to analyze the user's Wagering Data and generate periodic and/or real-time personalized wagering statistics; generating, with the computing device, an output illustrating the user's personalized wagering statistics; displaying, via the user interface, the output; and updating the user's Wagering Data and personalized wagering statistics.

Other aspects, embodiments, and features of the disclosed principles will become apparent from the following detailed description when considered together with the accompanying figures. In the figures, each identical or substantially similar component that is illustrated in various figures is represented by a single numeral or notation. For the purposes of clarity, not every component is labeled in every figure. Nor is every component of each embodiment of the disclosed principles shown where illustration is not necessary to allow those of ordinary skill in the art to understand the principles disclosed herein.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 is a block diagram of a system for generating personalized wagering statistics according to an illustrative embodiment;

FIG. 2 is a block diagram of a communications device for use in generating personalized wagering statistics according to an illustrative embodiment;

FIG. 3 is a block diagram of a computing device for generating personalized wagering statistics according to an illustrative embodiment;

FIG. 4 is an exemplary output for delivery to a user interface illustrating personalized wagering statistics according to an illustrative embodiment;

FIG. 5 is an exemplary output for delivery to a user interface illustrating wagering prompts according to an illustrative embodiment;

FIG. 6 is an exemplary output for delivery to a user interface illustrating wagering prompts according to an illustrative embodiment;

FIG. 7 is an exemplary output for delivery to a user interface illustrating personalized wagering statistics according to an illustrative embodiment;

FIG. 8 is an exemplary output for delivery to a user interface illustrating personalized wagering statistics according to an illustrative embodiment;.

FIG. 9 is an exemplary output for delivery to a user interface illustrating personalized wagering statistics according to an illustrative embodiment;

FIG. 10 is an exemplary output for delivery to a user interface illustrating prompts for creating a wagering pool according to an illustrative embodiment;

FIG. 11 is an exemplary output for delivery to a user interface illustrating a wagering pool according to an illustrative embodiment; and

FIG. 12 is a flowchart illustrating a method for generating personalize wagering statistics in accordance with an illustrative embodiment.

### DETAILED DESCRIPTION

Novel aspects of this disclosure recognize the need for a streamlined tool to collect, organize, and interpret personal Wagering Data more effectively. To this end, an improved computer program and system is provided that can generate real-time personalized wagering statistics based on the user's Wagering Data. The system provides an easy way to quickly and accurately calculate, process, and organize a user's personal Wagering Data and metrics for review. The system instantly calculates, tracks, and analyzes each user's Wagering Data on a team-by-team, wager-by-wager, and player-by-player basis in relation to game outcomes. The system provides each user with organized, easy-to-read data through a numerical system as well as graphs and charts which display the user's wagering statistics. More specifically, the system uses a “PA$$ Points System”, which numerically calculates the user's successful wagers (for both teams wagered on and against) as well as the user's unsuccessful wagers (for both teams wagered on and against) and displays the results using team-by-team and wager-by-wager scores, tables, and charts, as well as overall success scores. By offering periodic and/or real-time objective insight into each user's Wagering Data, the system provides a unique enhancement of the user's objective personal wagering knowledge, regardless of their level of expertise.

Novel aspects of this disclose also recognize the need for a tool to organize and operate private wagering pools. The system provides a customizable platform for multiple users to make predictions and compete throughout the season, chat, and view one another's personal wagering statistics in a private chat room environment.

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

As used herein, “PA$$ Simulated Wager” or “Pick” refers to a prediction regarding the outcomes of a contest, while “Bet” refers to an actual wager of money placed with a sportsbook or another third-party entity. As used herein, the term “wager” may refer to either or both of a PA$$ Simulated Wager or a Bet.

As used herein, “Against the Spread” (“ATS” or “The Spread”) refers to a wager that the favorite team will win by more than the point spread or the underdog team will lose by less than the point spread. The point spread is set for each game by oddsmakers to level the playing field between two mismatched teams. For example, in a match between Miami and Denver, the ATS may be 6 with Miami as the favorite. A wager on Miami [−6.0] wins if Miami wins the game by more than 6 points. On the other hand, a wager on Denver [+6.0] wins if Denver loses by less than 6 points. An outcome wherein Miami wins/Denver loses by exactly 6 points results in a “Push”, wherein the gambler is refunded on the bet.

As used herein, “Money Line” refers to a wager that a particular team (favorite or underdog) will win the game, regardless of The Spread. The payout is calculated based upon The Spread. For example, a wager of more than $100 is required to win $100 on a favorite, commensurate with The Spread. On the other hand, a wager of less than $100 is required to win $100 on an underdog, commensurate with The Spread.

As used herein, “Over/Under” refers to a wager on a game “Total” or the projected amount of points scored by both teams combined. The Total is set for each game by oddsmakers. An “Over” bet is a wager that the total combined score of the two teams will exceed the Total. An “Under”bet is a wager that the total combined score will not exceed the Total for the game.

As used herein, “Parlay” refers to a wager that combines multiple individual wagers into one wager. Individual wagers may consist of different types of wagers within one game, such as Money Line and/or ATS wagers. Individual wagers may also consist of wagers on two or more games. For the Parlay to win, all individual wagers must win. Because of this increased risk, the payout is higher, calculated based on the Money Line and/or ATS for each included game.

As used herein, “Teaser” refers to a wager that combines multiple wagers (like a Parlay), wherein The Spread and/or Over/Under are adjusted using a specific amount of allotted points for each team. For the Teaser to win, all individual wagers must win with the adjusted lines. The payout for a Teaser depends on the number of individual wagers and the points used to adjust The Spread and/or Over/Under.

As used herein, “Proposition Bets” refers to wagers placed on team's performance in games or in-game performances of one or more “Skill Position Players” such as the starting quarterback, running backs, wide receivers, and tight ends. Proposition Bets allow wagering on a team's performance or individual athlete's performance rather than the outcome of the game.

As used herein, “Last Man Standing” refers to a competition wherein participants pick one team each week that they believe will win its game. If the chosen team wins, the participant advances to the next round; if the team loses or draws, the participant is eliminated. The key rule is that a participant can only pick each team once per competition. The game continues until only one person is left standing to win the entire prize pool.

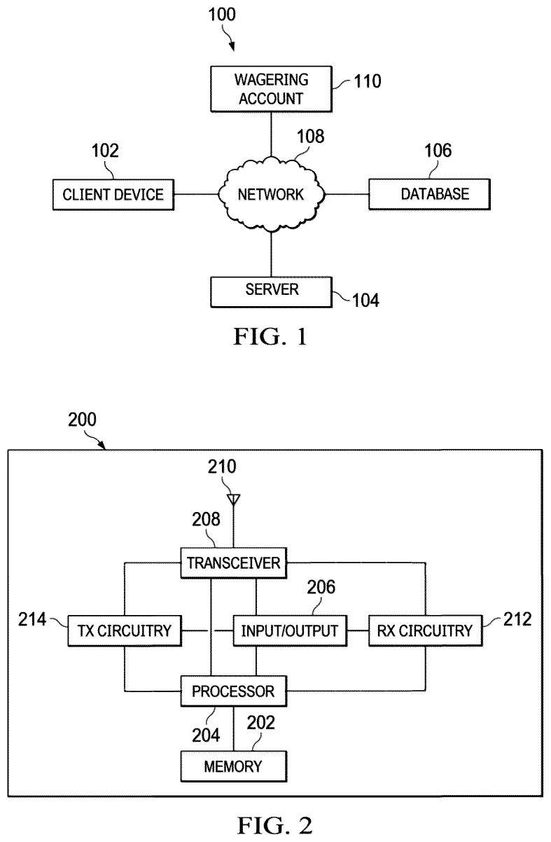

FIG. 1 is a block diagram of a system for generating personalized wagering statistics according to an illustrative embodiment. Generally, the system 100 includes one or more electronic client devices 102 communicating with a server 104 via a network 108. Examples of client devices 102 can include cell phones, tablets, desktop computers, or any other form of communications device that permits access to the server 104 via the network 108. An example of a client device 102 is shown in more detail in FIG. 2 that follows. The network 108 can include the internet, the Public Switched Telephone Network (PSTN), cellular networks, and local area networks, among others. Communication over the network 108 can be achieved using various forms of communications equipment and protocols. Based on the user's historical Wagering Data, server 104 can generate real-time personalized wagering statistics for presentation on the client device 102.

The server 104 is a computing device that can include hardware and software configured to generate personalized wagering statistics based on the user's historical Wagering Data. The server 104 may be referred to herein under the colloquial name PA$$ server 104. In an embodiment, the PA$$ server 104 may be artificial intelligence (AI)-enabled. Wagering Data can include multiple wager types, including Bets, PA$$ Simulated Wagers, wagers On and Against teams, ATS wagers, Over/Under wagers, Money Line wagers, Parlay wagers, Teaser wagers, and Proposition Bets. In an embodiment, the user's Wagering Data may be obtained from one or more of the user's wagering accounts 110. In the non-limiting exemplary embodiment illustrated in FIG. 1, the client device 102 and PA$$ server 104 may communicate with wagering accounts 110 via the network 108 to retrieve the user's Wagering Data. Automated acquisition of the user's Wagering Data from the user's wagering accounts 110 may be referred to herein using the colloquial name “PA$$ Sync”. In an embodiment, PA$$ Sync may be implemented through integration with a specialized third-party wagering data aggregation service, wherein the third-party service handles the authentication and data access to individual online sportsbooks, including credential management and data normalization across platforms. In an embodiment, data acquisition may be triggered by user login such that the system 100 initiates a pull of the user's latest wagering history when the user authenticates. PA$$ Sync may include background processing or “Asynchronous Handlers” for real-time updates pushed from the aggregation service. PA$$ Sync allows the user to upload all past and current Wagering Data into the system 100, by and through a third-party network. Implementing PA$$ Sync through integration with a specialized third-party wagering data aggregation service avoids the complexity of maintaining individual integrations with dozens of sportsbook Application Programming Interfaces (APIs), each with different authentication methods, data formats, and rate limits. Rather than maintaining brittle scraping scripts or managing dozens of API integrations, the user may simply connect their sportsbook website and/or app accounts to the system 100 once, and PA$$ Sync handles the rest automatically. In an embodiment, the user may manually input the user's Wagering Data using the client device 102. The user's Wagering Data may be stored in database 106. Database 106 may also include comprehensive sports information including team names, team rosters, game schedules, betting lines, and real-time score updates. This foundational data layer enables the correlation of user Wagering Data with actual game outcomes, facilitating the generation of personalized wagering statistics using inverse weighting analysis, discussed in greater detail below. In the exemplary embodiment, database 106 is stored remotely from the PA$$ server 104 and may be accessed by the PA$$ server 104 via the network 108. For example, database 106 may be a network attached storage (NAS) system. In an embodiment, database 106 may alternatively be integrated into the PA$$ server 104.

The PA$$ server 104 can use the user's Wagering Data to automatically generate real-time personalized wagering statistics that can then be presented to the user. Novel aspects of this disclosure allow a user the ability to review his Wagering Data through scores based on relative weight statistics. In one embodiment, the PA$$ server 104 generates the user's personalized wagering statistics using a team-based point reward/deduction formula. The team-based point reward/deduction formula may be referred to herein under the colloquial name PA$$ Points System. Using the PA$$ Points System, the user is assigned a score for each type of wager and each team upon which he has placed a Bet or PA$$ Simulated Wager. For each game, the user's wagers are compared to the outcomes and the user's team scores are awarded positive and negative points corresponding to the user's successful and unsuccessful wagers using the PA$$ Points System. Successful and unsuccessful wagers may be weighted differently, with unsuccessful wages associated with larger point values than successful wagers. Similarly, PA$$ Simulated Wagers and Bets may be weighted differently, with Bets being associated with larger point values than Picks. In a non-limiting example, in a game between Miami and Denver wherein Miami is the favorite and The Spread is 6, the user may Bet On Miami ATS [−6.0]. If Miami wins by 7 or more points, the user will be awarded +2.0 points to the user's Miami team for the successful Bet On Miami. The user will also be awarded +2.0 points to the user's Denver team for a successful Bet Against. On the other hand, if Miami does not win by 7 or more points, the user's Miami team will be awarded −2.5 points for an unsuccessful Bet On Miami. The user's Denver team will also be awarded −2.5 points for an unsuccessful Bet Against Denver. The same formula can be applied to PA$$ Simulated Wagers, but at reduced values. In an embodiment, a user's selected team may be awarded +0.5 points for a successful PA$$ Simulated Wager and −1.0 point for an unsuccessful PA$$ Simulated Wager.

The user's team scores are updated in real time after each game, thereby providing team scores that reflect the user's ability to accurately assess the strength of each team throughout the season. In a non-limiting example, if a user successfully Bets On Miami for three consecutive weeks, the user's Miami team will show +6.0 points. On the other hand, if the user unsuccessfully Bets On Miami for three consecutive weeks, the user's Miami team will show −7.5 points. In another non-limiting example, if a user successfully makes PA$$ Simulated Wagers On Miami for three consecutive weeks, the user's Miami team will show +1.5 points. On the other hand, if the user unsuccessfully PA$$ Simulated Wagers On Miami for three consecutive weeks, the user's Miami team will show −3.0 points. Over time, a user may see that his selections for a particular team have been adequately confirmed by actual results, indicating that the user has a substantially accurate understanding of the team and its abilities. On the other hand, a user may see that his selections for a particular team are disproven by actual results, indicating that the user does not have an accurate understanding of the team and its abilities and the user's wagering strategy needs refinement.

The user may also be assigned wager scores corresponding to the user's PA$$ Simulated Wagers and Bets, reflecting the user's overall wager accuracy throughout the season, regardless of team. As a non-limiting example, if a user successfully Bets On Miami (+2.0 points) and unsuccessfully Bets On the Dallas Cowboys (−2.5 points), the user's overall Bet score will be −0.5. Similarly, if a user successfully makes a PA$$ Simulated Wager On Miami (+0.5 points) and unsuccessfully PA$$ Simulated Wagers On the Dallas Cowboys (−1.0 points), the user's overall PA$$ Simulated Wager score will be −0.5. The user's wager scores may be updated periodically and/or in real time after each game, thereby providing wager scores that reflect the user's ability to accurately place PA$$ Simulated Wagers and Bets throughout the season. In a non-limiting example, if a user successfully Bets On Miami for three weeks (+6.0 points) and unsuccessfully Bets On the Dallas Cowboys for one week (−2.5 points), the user's overall Bet score will be +3.5. Similarly, if a user successfully makes a PA$$ Simulated Wager On Miami for three weeks (+1.5 points) and unsuccessfully makes a PA$$ Simulated Wager On the Dallas Cowboys for one week (−1.0 points), the user's overall Pick score will be +0.5. Over time, a user may see that his selections for wagers are confirmed by actual results, indicating that the user has a substantially accurate understanding of sports wagering. On the other hand, a user may see that his selections, as documented in his Wagering Data are disproved by actual results, indicating that the user's wagering strategy needs refinement. A user may also compare the outcomes of his PA$$ Simulated Wagers and Bets, further informing his wagering strategy.

The user's personalized wagering statistics can be provided to the user for review via a user interface, thereby enabling the user to make more informed wagering decisions throughout the season. The user interface may be provided by the client device 102, discussed in greater detail with references to FIG. 2 below. By offering real-time insight into the user's personal wagering metrics, the user may instantly record and track his Wagering Data through easily reviewable information.

The PA$$ server 104 is also configured to allow a user to create and manage a private wagering pool, wherein the user may invite multiple users to compete against one another. The user may set parameters for the wagering pool, such as the number and type of wagers that can be made each week and whether bonus wagers are available. Throughout the season, members of the wagering pool may place wagers and members may be ranked according to their success. Members may also view one another's personal wagering statistics and participate in a private chat room.

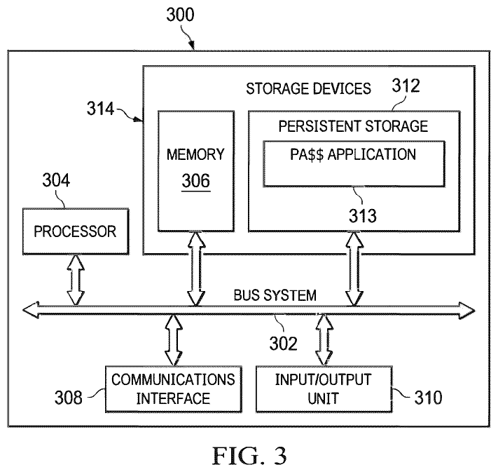

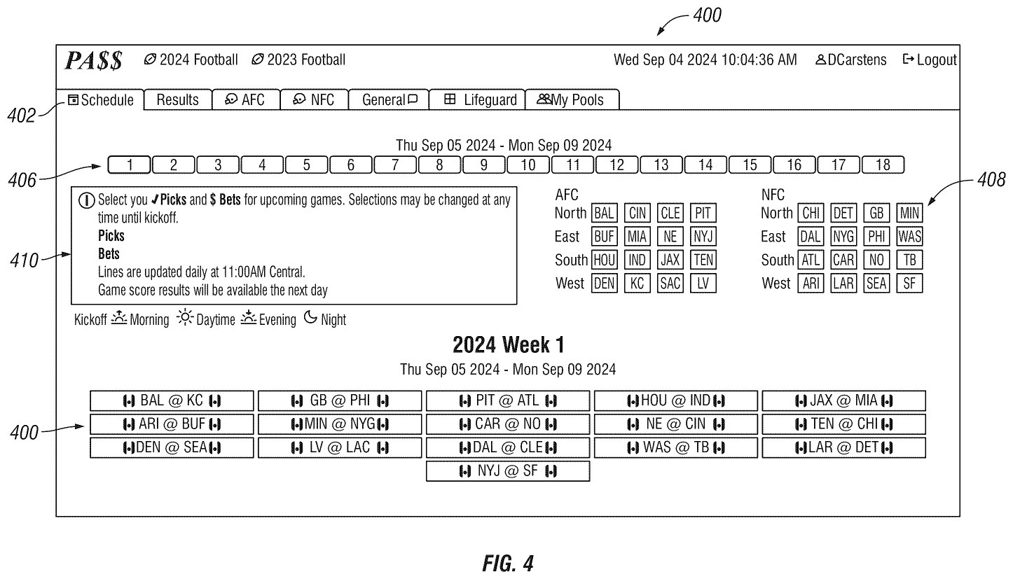

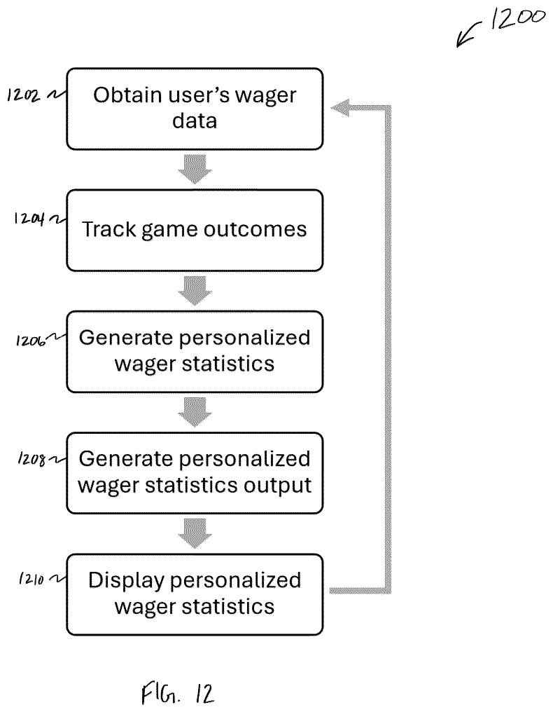

An example of the PA$$ server 104 shown in more detail in FIG. 3 that follows. Exemplary personalized wagering statistics are shown in FIGS. 4 and 7-9. An exemplary wagering pool is shown in more detail in FIG. 11.

FIG. 2 is a block diagram of a communications device for use in generating personalized wagering statistics utilizing the user's Wagering Data according to an illustrative embodiment. The client device 200 is provided for illustration only. The client devices 102 in FIG. 1 can have the same or similar configuration as the client device 200 in FIG. 2.

Client device 200 includes memory 202 storing instructions that can be executed by processor 204 for controlling the operation of the client device 200. For example, the memory can store an operating system and one or more applications that can be executed by the processor 204. The memory 202 can include random access memory (RAM), Flash memory, and/or read-only memory (ROM).

I/O 206 is one or more input/output (I/O) devices of the client device 200. Examples of I/O devices include, but are not limited to, a microphone, a speaker, a camera, a touch screen, and a keypad. I/O 206 enables a user to interact with the client device 200 to communicate with the PA$$ server.

The transceiver 208 provides a wireless communications capability with a network, such as network 108 in FIG. 1. Incoming signals are received by the transceiver 208 from the antenna 210 and processed by the receive (RX) circuity 212, which processes the signal and transmits the processed signal to an I/O device. The processed signal can also be transmitted to the processor 204 for further processing before presentation to a user on another I/O device. Outgoing signals transmitted by the transceiver 208 from the antenna 210 are received from transmit (TX) circuitry 214. The TX circuitry 214 can receive outgoing data, such as web data, e-mail, or application data, from the processor 204.

A user operating the client device 200 can direct Wagering Data from one or more wagering accounts to the PA$$ server, which can be used to generate personalized wagering statistics utilizing relative weighted scoring.

FIG. 3 is a block diagram of a computing device for generating personalized wagering statistics utilizing relative weighted scoring according to an illustrative embodiment. For example, the server 300 can be a PA$$ server 104 in FIG. 1.

Server 300 includes a bus system 302 that supports communication between at least one processor 304, at least one storage device 314, at least one communications interface 308, and at least one input/output (I/O) unit 310.

The memory 306 and a persistent storage 312 are examples of storage devices 314, which represent any structure(s) capable of storing and facilitating retrieval of information (such as data, program code, and/or other suitable information on a temporary or permanent basis), including but not limited to data associated with the database. The memory 306 may represent a random access memory or any other suitable volatile or non-volatile storage device(s). The persistent storage 312 may contain one or more components or devices supporting longer-term storage of data, such as a read only memory, hard drive, Flash memory, or optical disc.

The processor 304 may execute instructions that may be loaded into the memory 306. The processor 304 may include any suitable number(s) and type(s) of processors or other devices in any suitable arrangement. Example types of processors 304 include microprocessors, microcontrollers, digital signal processors, field programmable gate arrays, application specific integrated circuits, and discreet circuitry.

The communications interface 308 may support communications with other systems or devices. For example, the communications interface 308 could include a network interface card or a wireless transceiver facilitating communications over the network 108. The communications interface 308 may support communications through any suitable physical or wireless communication link(s).

The I/O unit 310 may allow for input and output of data. For example, the I/O unit 310 may provide a connection for user input through a keyboard, mouse, keypad, touchscreen, or other suitable input device. The I/O unit 310 may also send output to a display, printer, or other suitable output device.

As previously described, the server 300 can be implemented as a PA$$ server in a networked computing system that can automatically generate personalized wagering statistics based on the user's Wagering Data. In this illustrative embodiment, a PA$$ application 313 hosted on the server 300 can be used for managing the generation of personalized wagering statistics utilizing relative weighted scoring.

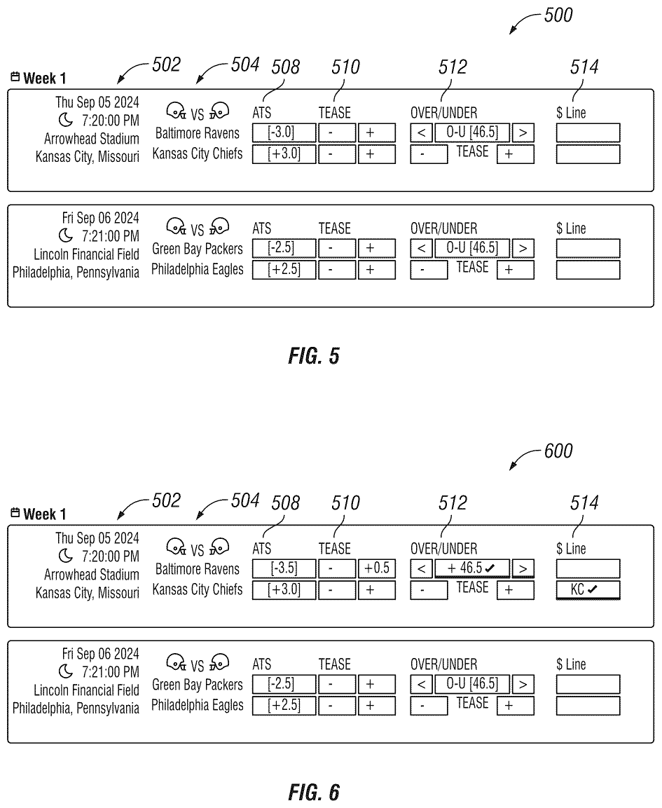

FIGS. 4-9 illustrate exemplary outputs for display on a user interface in accordance with the disclosed principles. The output may include a dashboard with a plurality of tabs for navigating between various pages. Referring to FIG. 4, illustrated is an output 400 depicting information regarding upcoming contests for which wagers may be placed. In the non-limiting exemplary embodiment illustrated in FIG. 4, output 400 may be associated with the Schedule tab 402 depicting information regarding the plurality of contests 404 occurring in a selected time period. The user may select the time period for which contests 402 are displayed by selecting a week from the list of weeks 406 in the season. In the non-limiting exemplary embodiment illustrated in FIG. 4, contests 404 may include a list of football games played in week 1 of the 2024 season. The user may select, via the user interface, one or more of the plurality of contests 404 for a given time period to view additional contest data and input wagers for the selected contests, discussed in more detail with reference to FIG. 5. The output 400 may also include a list of teams 408 organized by league and division. The output 400 may also include personalized wagering statistics based on the user's Wagering Data. In an embodiment, the user's personalized wagering statistics may include wager scores 410 for the user's Picks and Bets. In an embodiment, wager scores 410 may be shown as a net score for each of the Picks and Bets, reflecting the total points awarded to the user for each of the Picks and Bets. In the non-limiting exemplary embodiment illustrated in FIG. 4, wager scores 410 may be displayed as a score breakdown, wherein the positive and negative points contributing to the net scores are displayed. As shown in FIG. 4, the user's Picks wager score 410 is [+0.5]/[−1.0], illustrating that the user has been awarded +0.5 points on successful Picks and −1.0 points on unsuccessful Picks. The user's Bets wager score 410 is [+2.0]/[−2.5], illustrating that the user has been awarded +2.0 points on successful Bets and −2.5 points on unsuccessful Bets. Using the example provided in FIG. 4, the user's Picks wager score 410 and Bets wager score 410 may additionally or alternatively be displayed as +0.5 and −0.5, respectively.

Referring to FIG. 5, illustrated is an output 500 depicting wager prompts in accordance with the disclosed principles. Output 500 may include additional contest data 502 such as time and location of the selected contest 504. Output 500 may also include prompts 506, wherein the user may input one or more wagers for the selected contest 504. Prompts 506 may include, for example, ATS 508, Tease 510, Over/Under 512, and Money Line 514 wagers. The ATS 508 may include the ATS for each team as set by oddsmakers for the selected contest 504. In the non-limiting exemplary embodiment illustrated in FIG. 5, ATS 508 may be [−3.0] for the Baltimore Ravens and [+3.0] for the Kansas City Chiefs. To input an ATS wager, the user may select the ATS 508 prompt corresponding to the desired team. Tease 510 may include minus and plus signs to allow the user to adjust the ATS 508 for each team in the selected contest 504 to input a Teaser wager. An exemplary Teaser wager is illustrated in FIG. 6 that follows. Over/Under 512 may include the Over/Under for the game as set by oddsmakers for the selected contest 504. In the non-limiting embodiment illustrated in FIG. 5, the Over/Under 512 may be 46.5. Over/Under 512 may also include minus and plus signs to allow the user to adjust the Over/Under to input a Teaser wager. To input a Money Line wager, the user may select the Money Line 514 prompt corresponding to the desired team.

Referring to FIG. 6, illustrated is an output 600 depicting the user's wagers for the selected contests in accordance with the disclosed principles. As previously discussed, the user may input one or more wagers for the selected contests 504 by selecting from a plurality of prompts 506. In the non-limiting exemplary embodiment illustrated in FIG. 6, a Teaser wager is depicted. Using the Tease 510 prompt, the ATS for the Baltimore Ravens is increased by 0.5, thereby modifying the ATS 508 for the Ravens to [−3.5]. The adjusted ATS 508 is selected, indicating a wager that the Ravens will win the game by more than 3.5 points. Over/Under 512 is also selected, indicating a wager that the Total will be at least 46.5 points. Using the Money Line 514 prompt, Kansas City is selected, indicating a wager that the Chiefs will win the game. In an embodiment, the user may input one or more types of wagers, including but not limited to PA$$ Simulated Wagers and Bets. PA$$ Simulated Wagers and Bets may be associated with unique symbols to illustrate the type of wager being input. In an embodiment, PA$$ Simulated Wagers may be associated with a checkmark while Bets may be associated with a currency sign. In the non-limiting exemplary embodiment illustrated in FIG. 6, the depicted Teaser wager includes checkmarks, indicating a Teaser PA$$ Simulated Wager.

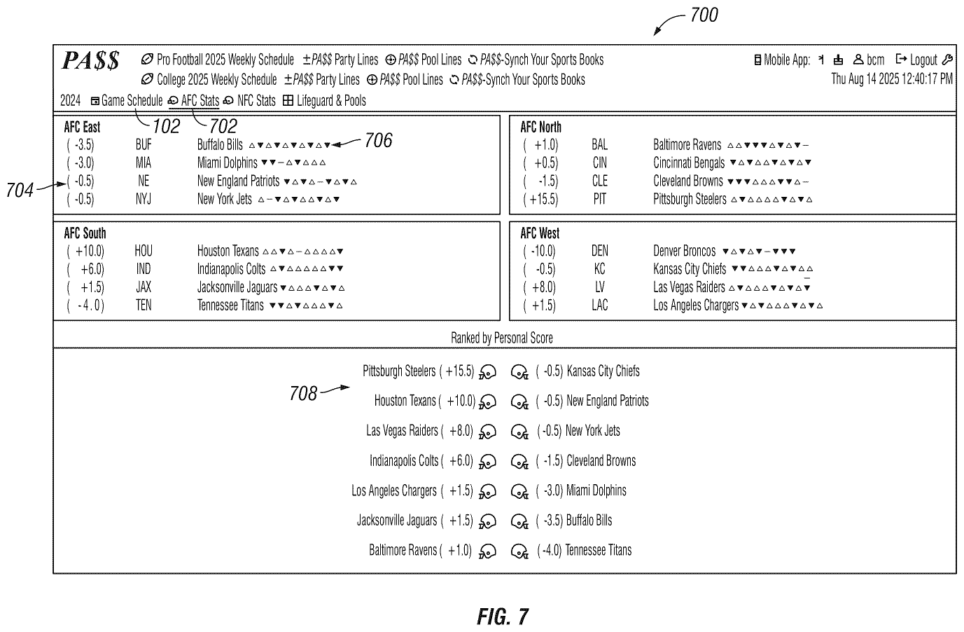

Referring to FIG. 7, illustrated is an output 700 depicting the user's personalized wagering statistics for all teams in a selected league. As previously discussed, the system may calculate, track, and analyze each user's entire personal Wagering Data on a team-by-team basis. In the non-limiting exemplary embodiment illustrated in FIG. 7, output 700 may be associated with AFC Stats tab 702 depicting the user's personalized wagering statistics for teams in the American Football Conference. In an embodiment, the teams in the league may be organized according to division. The user's personalized wagering statistics may include team scores 704 for each team in the league, reflecting the cumulative total of the user's earned points from successful and unsuccessful PA$$ Simulated Wagers and Bets On and Against the corresponding team. A positive team score 704 indicates that the user's wagers for a particular team are confirmed by actual results, indicating that the user has a substantially accurate understanding of the team and its abilities. A negative team score 704 indicates that the user's selections for a particular team are disproven by actual results, indicating that the user does not have an accurate understanding of the team and its abilities. In an embodiment, positive team scores 704 may be visually differentiated from negative team scores 704. For example, positive team scores 704 may be shown in green while negative team scores 704 may be shown in red. The magnitude of the team score 704 indicates the extent to which the user's selections are confirmed or disproven. In the non-limiting exemplary embodiment illustrated in FIG. 7, the user's team score 704 for the Pittsburgh Steelers is (+15.5) and the user's team score for the Tennessee Titans is (−4.0), indicating that the user's Wagering Data confirms the user has a strong understanding of the Pittsburgh Steelers and a poor understanding of the Tennessee Titans.

The user's personalized wagering statistics may also include trend indicators 706 for each team, illustrating the shift of the user's team score 704 each week. In an embodiment, upward arrows may indicate a positive shift in the user's team score 704 for the week, while downward arrows may indicate a negative shift in the user's team score 704. A line may indicate no change in the user's team score 704 for the week. For example, in the non-limiting exemplary embodiment illustrated in FIG. 7, the user's trend indicator 706 for the Buffalo Bills indicates that the user's team score 704 for the Buffalo Bills alternately increased and decreased each week.

Output 700 may also include a personalized team ranking 708, wherein the teams in the league are ranked according to the user's team score for each team. Team ranking 708 allows the user to quickly appreciate the teams for which he has the strongest and weakest understanding, thereby informing his future wagering strategy.

As previously discussed, the user's personalized wagering statistics are updated after each game, thereby providing personalized wagering statistics that reflect the user's ability to accurately assess the strength of each team throughout the season. With reference to FIG. 7, the user's team score 704, trend indicators 706, and team ranking 708 may be updated after each game.

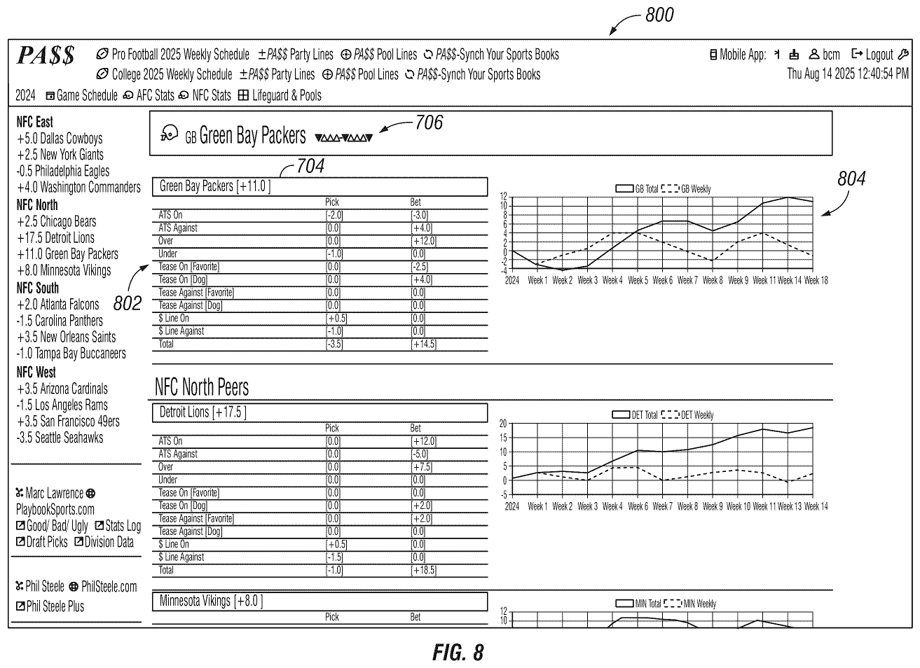

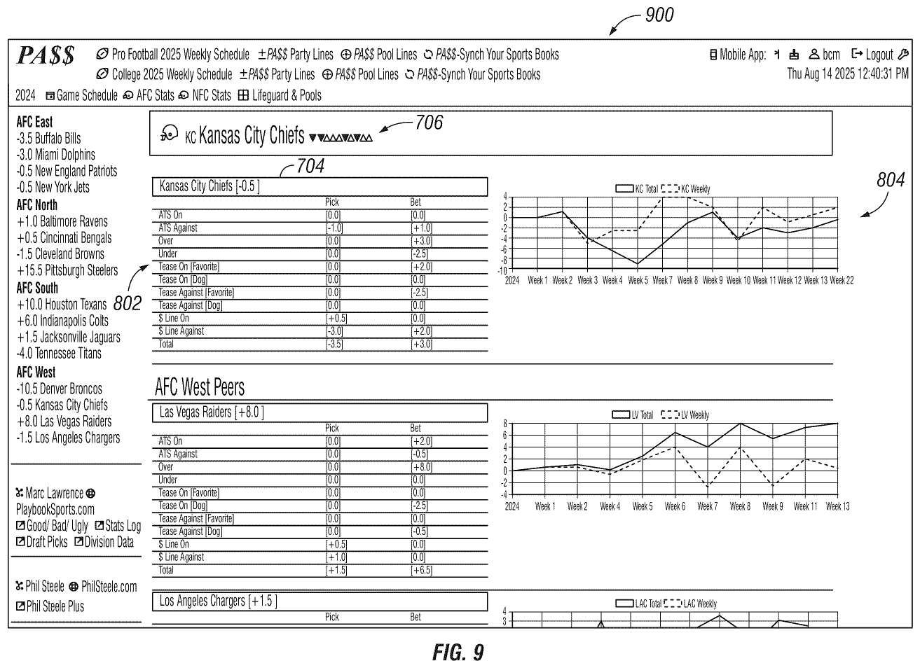

Referring to FIGS. 8 and 9, illustrated are outputs 800 and 900, respectively, depicting detailed views of the user's personalized wagering statistics for selected teams. As previously discussed, the system may calculate, track, and analyze the user's personal Wagering Data on a team-by-team and wager-by-wager basis. In the non-limiting exemplary embodiment illustrated in FIGS. 8 and 9, personalized wagering statistics may include one or more tables 802 depicting the outcomes of the user's wagers throughout the season. Table 802 may include a list showing the sum of points awarded to the user throughout the season. In an embodiment, table 802 may differentiate points associated with PA$$ Simulated Wagers from points associated with Bets. For example, points associated with PA$$ Simulated Wagers and Bets may be organized into separate lists. Points associated with PA$$ Simulated Wagers and Bets may also be differentiated by color. Table 802 may further organize points according to wager type, including but not limited to ATS, Over, Under, Teasers, Money Line, On, Against, Favorite, and Underdog. Table 802 may also provide a PA$$ Simulated Wager Total, illustrating the total points earned for the team from the user's PA$$ Simulated Wagers throughout the season, regardless of wager type. Table 802 may also provide a Bet Total, illustrating the total points earned for the team from the user's Bets throughout the season, regardless of wager type. The team score 704 is the sum of the PA$$ Simulated Wager Total and Bet Total for the team. Personalized wagering statistics may also include one or more graphs 804 illustrating the outcomes of the user's wagers throughout the season. In an embodiment, graph 804 may depict the change in team score 704 throughout the season as well as the points awarded in accordance with the PA$$ Points System to the user each week, thereby illustrating trends in the user's wagering outcomes for the teams and wagers.

As previously discussed, personalized wagering statistics may also include the team score 704 and the trend indicators 706 for the selected team. Outputs 800 and 900 may also include personalized wagering statistics associated with teams in the same league and division as the selected team. For example, in the non-limiting exemplary embodiment illustrated in FIG. 8, output 800 may include a detailed view of the user's personalized wagering statistics for the selected team, the Green Bay Packers, as well as a detailed view of the user's personalized wagering statistics for other teams in the same league and division, namely the Detroit Lions and the Minnesota Vikings.

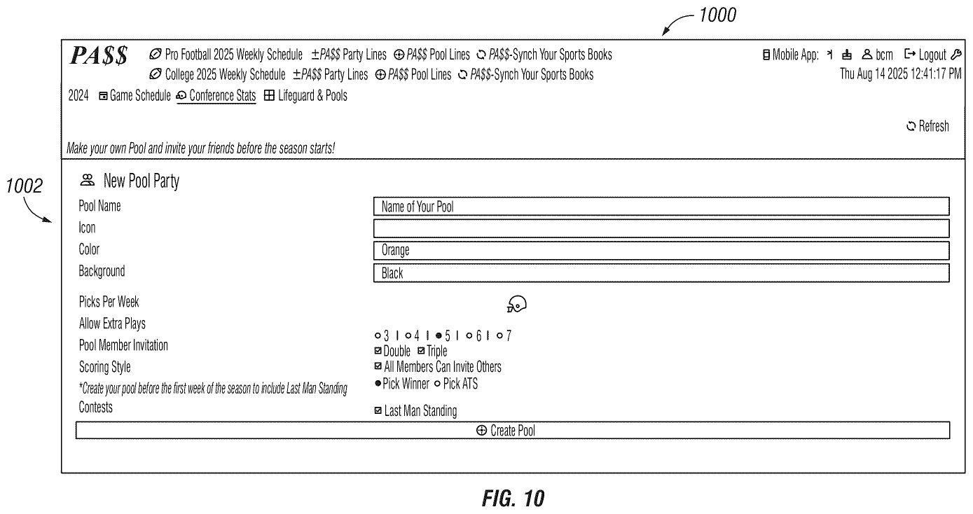

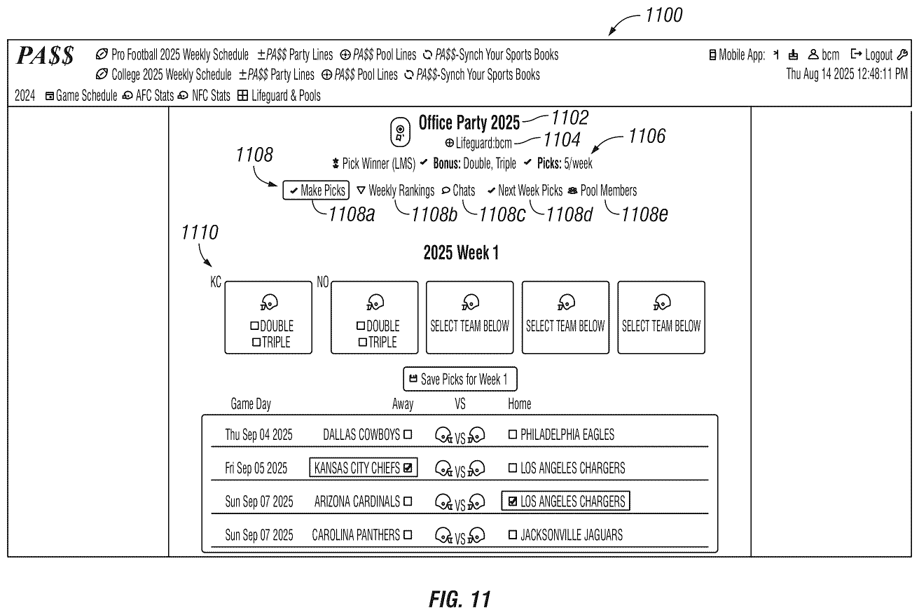

Referring to FIG. 10, illustrated is an output 1000 for creating a wagering pool. As previously discussed, the PA$$ server is configured to allow private wagering pools, wherein multiple users can compete against one another. A user may create and set parameters for a wagering pool using the client device. In the non-limiting exemplary embodiment illustrated in FIG. 10, output 1000 may include prompts 1002 whereby the user may select a name, icon, color, and background for the wagering pool. Output 1000 may also include prompts 1002 whereby the user may select, for example, the number of wagers that can be made each week, whether extra plays are allowed, invitation permissions, and scoring style, including money line and ATS wagers, and the like. Output 1000 may also include prompts 1002 whereby the user may select whether the wagering pool will include a Last Man Standing competition. The wagering pool is discussed in greater detail with reference to FIG. 11 below.

Referring to FIG. 11, illustrated is an output 1100 depicting a wagering pool. In the non-limiting exemplary embodiment illustrated in FIG. 11, output 1100 may include the wagering pool name 1102, the identity of the managing user 1104, and the wagering pool parameters 1106. Output 1100 may also include a plurality of tabs 1108 for navigating the wagering pool. As shown in FIG. 11, the Make Picks tab 1108a is selected. The Make Picks tab 1108a provides a list of prompts 1110 whereby the members of the wagering pool may place wagers throughout the season. As previously discussed, members may be ranked according to their success throughout the season. Wagering pool rankings may be reviewed using the Weekly Rankings tab 1108b. Members may participate in a private chat room using the Chat tab 1108c and view the available wagers for the upcoming week using the Next Week Picks tab 1108d. Members may view one another's personal wagering statistics using the Pool Members tab 1108e. The system provides a centralized platform for multiple users to participate in a wagering pool, wherein the members of the wagering pool may compete against one another and view one another's personalized wagering statistics.

Referring to FIG. 12, illustrated is flowchart 1200 depicting a process for generating personalized wagering statistics in accordance with an illustrative embodiment. The process can be implemented in a server, such as PA$$ server 104 in FIG. 1. Flowchart 1200 begins at Step 1202 by obtaining the user's personal Wagering Data. The user's Wagering Data may be obtained from the user's wagering accounts via a network. Additionally or alternatively, the user's personal Wagering Data may be obtained from user input via a client device. In Step 1204, the outcomes of a plurality of games are tracked. In Step 1206, personalized wagering statistics are generated using relative weight statistics as described above. The user may be awarded positive points for successful wagers and negative points for unsuccessful wagers. Personalized wagering statistics may include a team score for each team, as well as wagering scores reflecting the user's overall PA$$ Simulated Wager and Bet accuracy, irrespective of team. Personalized wagering statistics may also include points awarded to the user for each wager type. In Step 1208, outputs illustrating the user's personal wagering statistics are generated for review by the user. In Step 1210, the outputs may be provided to the user on one or more client devices. The outputs may include tables, scores, trend indicators, ranked lists, and graphs. As shown in FIG. 12, flowchart 1200 may repeat such that the user's Wagering Data and personal wagering statistics are updated after each game, thereby providing the user with up-to-date personal wagering statistics throughout the season.

While this disclosure has been particularly shown and described with reference to preferred embodiments, it will be understood by those skilled in the pertinent field of art that various changes in form and detail may be made therein without departing from the spirit and scope of the disclosed principles. The inventors expect skilled artisans to employ such variations as appropriate, and the inventors intend the disclosed principles to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, including but not limited to the subsequent use of AI in the system, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F. R. 1.77 or otherwise to provide organizational cues. These headings shall not limit or characterize the disclosed principles set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” or disclosed principles in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F. R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

We claim:

1. A non-transitory computer-readable medium storing instructions that, when executed by one or more processors, cause the one or more processors to perform operations for analyzing a user's wagering data, the operations comprising:
receiving the user's wagering data;
tracking outcomes of a plurality of games;
executing an algorithm to analyze the user's wagering data and generate personalized wagering statistics; and
generating an output illustrating the personalized wagering statistics.

2. The non-transitory computer-readable medium of claim 1, wherein receiving the user's wagering data comprises communicating with the user's wagering account via a network.

3. The non-transitory computer-readable medium of claim 1, wherein receiving the user's wagering data comprises receiving manual input from the user.

4. The non-transitory computer-readable medium of claim 1, wherein the algorithm compares the user's wagering data to the outcomes and award points to generate personalized wagering statistics.

5. The non-transitory computer-readable medium of claim 4, wherein unsuccessful wagers are more heavily weighted than successful wagers and money wagers are more heavily weighted than prediction wagers.

6. The non-transitory computer-readable medium of claim 4, wherein personalized wagering statistics include a plurality of team scores and wager scores, wherein each team score is a sum of the points awarded to the user for a particular team and the wager score is a sum of the points awarded to the user for a particular wager type.

7. The non-transitory computer-readable medium of claim 1, wherein the output includes team scores, wager scores, tables, graphs, charts, trend indicators, and ranked lists.

8. The non-transitory computer-readable medium of claim 1, further comprising the operation of generating a wagering pool for competition among multiple users.

9. A system for analyzing a user's wagering data, comprising:
a database configured to receive and store the user's wagering data and game information;
a computing device configured to analyze the user's wagering data and generate personalized wagering statistics; and
a user interface configured to present the personalized wagering statistics to the user, wherein the database, computing device, and user interface are communicatively coupled.

10. The system of claim 9, wherein receiving the user's wagering data comprises communicating with the user's wagering account via a network.

11. The system of claim 9, wherein receiving the user's wagering data comprises receiving manual input from the user.

12. The system of claim 9, wherein the computing device comprises:
a communications interface that receives data from a network;
a memory storing instructions for generating personalized wagering statistics based on the user's wagering data; and
a processor communicatively coupled with the communications interface and the memory, and wherein the processor executes the instructions to:
retrieve the user's wagering data;
track outcomes of a plurality of games;
execute an algorithm to analyze the user's wagering data and generate personalized wagering statistics; and
generate an output for delivery to the user interface.

13. The system of 12, wherein the algorithm compares the user's wagering data to the outcomes and award points to the user based on the success of the user's wagers to generate personalized wagering statistics.

14. The system of 13, wherein unsuccessful wagers are more heavily weighted than successful wagers and money wagers are more heavily weighted than prediction wagers.

15. The system of 13, wherein personalized wagering statistics include a plurality of team scores and wager scores, wherein each team score is a sum of the points awarded to the user for a particular team and the wager score is a sum of the points awarded to the user for a particular wager type.

16. The system of 12, wherein the output includes team scores, wager scores, tables, graphs, charts, trend indicators, and ranked lists.

17. The system of 12, further comprising instructions to generate a wagering pool for competition among multiple users.

18. A method for analyzing a user's wagering data, comprising:
receiving the user's wagering data;
tracking outcomes of a plurality of games;
executing, with a computing device, an algorithm to analyze the user's wagering data and generate personalized wagering statistics;
generating, with the computing device, an output illustrating the user's personalized wagering statistics;
displaying, via the user interface, the output; and
updating the user's wagering data and personalized wagering statistics.

19. The method of claim 18, wherein receiving the user's wagering data comprises communicating with the user's wagering account via a network.

20. The method of claim 18, wherein receiving the user's wagering data comprises receiving manual input from the user.

21. The method of claim 18, wherein the algorithm compares the user's wagering data to the outcomes and awards points to the user based on the success of the user's wagers to generate personalized wagering statistics.

22. The method of claim 21, wherein unsuccessful wagers are more heavily weighted than successful wagers and money wagers are more heavily weighted than prediction wagers.

23. The method of claim 21, wherein personalized wagering statistics include a plurality of team scores and wager scores, wherein each team score is a sum of the points awarded to the user for a particular team and the wager score is a sum of the points awarded to the user for a particular wager type.

24. The method of claim 18, wherein the output includes team scores, wager scores, tables, graphs, charts, trend indicators, and ranked lists.

25. The method of claim 18, further comprising generating a wagering pool for competition among multiple users.
